(19) United States
(12) Patent Application Publication
(10) Pub. No.: US 2024/0286618 A1
(43) Pub. Date: Aug. 29, 2024

(54) SENSING DEVICE AND VEHICLE CONTROL DEVICE

(71) Applicant: Hitachi Astemo, Ltd., Hitachinaka-shi, Ibaraki (JP)

(72) Inventors: Morihiko SAKANO, Tokyo (JP); Hideyuki KUME, Tokyo (JP); Takehito OGATA, Tokyo (JP); Hidehiro TOYODA, Ibaraki (JP)

(73) Assignee: Hitachi Astemo, Ltd., Hitachinaka-shi, Ibaraki (JP)

(21) Appl. No.: 18/565,467

(22) PCT Filed: Feb. 8, 2022
(86) PCT No.: PCT/JP2022/004980

§ 371 Date: Nov. 29, 2023

(30) Foreign Application Priority Data
Jun. 17, 2021 (JP) 2021-100680

(51) Int. Cl. B60W 40/06; B60W 40/11; B60W 40/112; G06V 20/56

(52) U.S. Cl. CPC B60W 40/06; B60W 40/11; B60W 40/112; G06V 20/588; B60W 2420/403; B60W 2520/16; B60W 2520/18; B60W 2556/35

(57) ABSTRACT

A sensing device includes a first common image pickup region observation unit that observes a first region in a periphery of a host vehicle from information of a common image pickup region acquired by at least a first sensor and a second sensor having the common image pickup region, a second common image pickup region observation unit that observes a second region different from the first region from information of a common image pickup region acquired by at least a third sensor and a fourth sensor having the common image pickup region, a coordinate integration unit that integrates a geometric relationship between the sensors with coordinates of pieces of information observed in the first region and the second region, and a road surface estimation unit that estimates a relative posture between each sensor and a road surface including a pitch angle and a roll angle of the host vehicle based on point group information calculated from the integrated coordinates.

### INCORPORATION BY REFERENCE

This application is based upon and claims the benefit of priority from Japanese Patent Application No. 2021-100680, filed on Jun. 17, 2021; the entire contents of which are incorporated herein by reference.

### TECHNICAL FIELD

The present invention relates to a sensing device and a vehicle control device.

### BACKGROUND ART

On-vehicle cameras have become widespread for the purpose of driver assistance and automated driving, and a plurality of monocular cameras may be mounted for surrounding monitoring and the like. In the driver assistance and the automated driving, one of requirements for the on-vehicle camera is distance measurement of an object. In the distance measurement of the object using the monocular camera, it is assumed that a road surface is a plane, and a distance corresponding to each pixel of the on-vehicle camera can be calculated from a relationship between an attachment state of the on-vehicle camera and the road surface. However, in a case where the road surface has a gradient, there is a problem that an error occurs in the measured distance when the calculation is performed on the assumption that the road surface is the plane. In particular, the error increases as the distance increases. Accordingly, it is necessary to reduce the influence of a gradient error.

PTL 1 discloses a gradient estimation device based on an imaged image imaged by a camera. The gradient estimation device includes a camera, a road surface grounding position calculation unit, a distance measurement sensor, and a gradient estimation unit. The road surface grounding position calculation unit calculates a distance L2 to a road surface grounding position of an object reflected in the imaged image based on the imaged image imaged by the camera. The gradient estimation device calculates a distance L1 to the object by using the distance measurement sensor. The gradient estimation unit estimates a gradient β of a straight line passing through an intersection of a perpendicular line drawn from a position of the camera and a horizontal plane and a predetermined point A1 indicating the object based on a depression angle α of the camera, the distance L2, and the distance L1.

### SUMMARY OF INVENTION

### Technical Problem

In PTL 1, it is assumed that a distance measurement sensor of an active laser system is used, and it is difficult to perform distance correction in a case where there is no sensor capable of measuring the distance regardless of the gradient.

Therefore, an object of the present invention is to provide a sensing device that estimates a relative posture between a road surface and a vehicle with high accuracy.

### Solution to Problem

A typical example of the invention disclosed in the present application is as follows. That is, a sensing device includes a first common image pickup region observation unit that observes a first region in a periphery of a host vehicle from information of a common image pickup region acquired by at least a first sensor and a second sensor having the common image pickup region, a second common image pickup region observation unit that observes a second region different from the first region from information of a common image pickup region acquired by at least a third sensor and a fourth sensor having the common image pickup region, a coordinate integration unit that integrates a geometric relationship between the sensors with coordinates of pieces of information observed in the first region and the second region, and a road surface estimation unit that estimates a relative posture between each sensor and a road surface including a pitch angle and a roll angle of the host vehicle based on point group information calculated from the integrated coordinates.

### Advantageous Effects of Invention

According to one aspect of the present invention, it is possible to reduce the influence of the road gradient and the vehicle posture and to improve the distance measurement accuracy. Other objects, configurations, and effects will be made apparent in the following descriptions of the embodiments.

### BRIEF DESCRIPTION OF DRAWINGS

FIG. 1 is a block diagram illustrating a configuration of a vehicle on which a sensing device according to an embodiment of the present invention is mounted.

FIG. 2 is a diagram illustrating an example of a relationship between a camera and a common image pickup region.

FIG. 3 is a diagram illustrating an example of a gradient and a vehicle posture variation.

FIG. 4 is a functional block diagram of a distance estimation program executed by a CPU.

FIG. 5 is a schematic diagram illustrating kinds of processing of coordinate integration and road surface model collation.

FIG. 6 is a flowchart of kinds of processing executed by a first common image pickup region observation unit.

FIG. 7 is a schematic diagram illustrating a modification example of kinds of processing of coordinate integration and road surface model collation of modification example 1.

FIG. 8 is a flowchart of kinds of processing executed by a first common image pickup region observation unit of Modification Example 1.

FIG. 9 is a schematic diagram illustrating a further modification example of kinds of processing of coordinate integration and road surface model collation of Modification Example 2.

FIG. 10 is a functional block diagram of a distance estimation program executed by a CPU of Modification Example 2.

FIG. 11 is a block diagram illustrating a configuration of a vehicle on which a sensing device of Modification Example 3 is mounted.

FIG. 12 is a diagram illustrating an example of a relationship between a camera and a common image pickup region of Modification Example 3.

FIG. 13 is a functional block diagram of a distance estimation program executed by a CPU of Modification Example 3.

### DESCRIPTION OF EMBODIMENTS

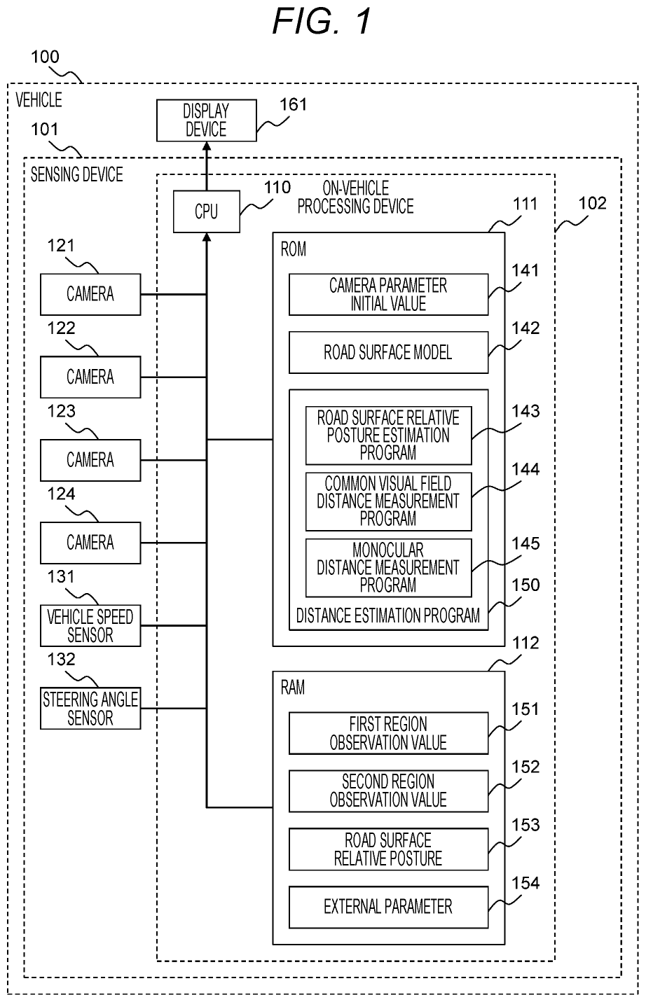

Hereinafter, an embodiment of a sensing device 101 according to the present invention will be described with reference to FIGS. 1 to 13.

FIG. 1 is a block diagram illustrating a configuration of a vehicle 100 on which the sensing device 101 according to the embodiment of the present invention is mounted.

The sensing device 101 includes cameras 121 to 124, a vehicle speed sensor 131, a steering angle sensor 132, a display device 161, and an on-vehicle processing device 102. The cameras 121 to 124, the vehicle speed sensor 131, the steering angle sensor 132, and the display device 161 are connected to the on-vehicle processing device 102 via a signal line, and exchange various kinds of data with the on-vehicle processing device 102.

Although described in detail later, the cameras 121 to 124 are attached to a periphery of the vehicle 100 and captures the periphery of the vehicle 100. A capturing range of the cameras 121 to 124 includes a road surface on which the vehicle 100 travels. A positional and postural relationship between the cameras 121 to 124 and the vehicle 100 is stored as a camera parameter initial value 141 in a ROM 111.

Each of the cameras 121 to 124 includes a lens and an image pickup element, and these characteristics, for example, internal parameters such as a lens distortion coefficient which is a parameter indicating distortion of the lens, an optical axis center, a focal length, and the number of pixels and dimensions of the image pickup element are also stored as the camera parameter initial value 141 in the ROM 111.

The vehicle speed sensor 131 and the steering angle sensor 132 measure a vehicle speed and a steering angle of the vehicle 100 on which the on-vehicle processing device 102 is mounted, respectively, and output the vehicle speed and the steering angle to a CPU 110. The on-vehicle processing device 102 calculates a movement amount and a movement direction of the vehicle 100 on which the on-vehicle processing device 102 is mounted by a known dead reckoning technique by using outputs of the vehicle speed sensor 131 and the steering angle sensor 132.

The on-vehicle processing device 102 includes the CPU 110 which is a central processing unit, the ROM 111, and a RAM 112. All or a part of arithmetic processing may be executed by another arithmetic processing device such as an FPGA.

The CPU 110 operates as an execution unit of the on-vehicle processing device 102 by reading and executing various programs and parameters from the ROM 111.

The ROM 111 is a read-only storage region, and stores the camera parameter initial value 141, a road surface model 142, and a distance estimation program 150.

The camera parameter initial value 141 is a numerical value indicating a relationship between positions and the postures of the cameras 121 to 124 and the vehicle 100. The cameras 121 to 124 are attached to the vehicle 100 in positions and postures based on a design, but it is inevitable that an error occurs in the attachment. Thus, for example, when the vehicle 100 is shipped from a factory, calibration is executed by using a predetermined test pattern or the like in the factory, and a correctly corrected value is calculated. The camera parameter initial value 141 stores a relationship between a position and a posture correctly corrected after the execution of the calibration. In addition, correction values after calibration execution of characteristics of the lens and the image pickup element, for example, the internal parameters such as the lens distortion coefficient which is the parameter indicating the distortion of the lens, the optical axis center, the focal length, and the number of pixels and dimensions of the image pickup element are also stored.

The road surface model 142 models a road surface gradient, and quantifies and stores a model type thereof and a parameter thereof. The road surface model 142 is used when a road surface relative posture 153 is calculated in a road surface relative posture estimation program 143 in the distance estimation program 150. Details of the road surface model 142 will be described later.

The distance estimation program 150 includes a road surface relative posture estimation program 143, a common visual field distance measurement program 144, and a monocular distance measurement program 145, which will be described later. These programs are read from the ROM 111, is loaded to the RAM 112, and is executed by the CPU 110.

The RAM 112 is a readable and writable storage region, and operates as a main storage device of the on-vehicle processing device 102. The RAM 112 stores a first region observation value 151, a second region observation value 152, a road surface relative posture 153, and an external parameter 154, which will be described later.

The first region observation value 151 is observation data including a road surface and a three-dimensional object in a region observed by the common visual field distance measurement program 144 and observed in a common visual field of the camera 121 and the camera 122. The first region observation value 151 is obtained by calculating a feature point of a common object including the road surface and the three-dimensional object in the common visual field and a distance of the feature point from a known relative relationship between the camera 121 and the camera 122 and the internal parameters recorded in the camera parameter initial value 141, and storing three-dimensional coordinates calculated from the distance. The first region observation value 151 is used in the road surface relative posture estimation program 143.

The second region observation value 152 is observation data including a road surface and a three-dimensional object in a region observed by the common visual field distance measurement program 144, having processing contents common to the first region observation value 151, and observed in a common visual field of the camera 123 and the camera 124. The second region observation value 152 is obtained by calculating a feature point of a common object including the road surface and the three-dimensional object in the common visual field and a distance of the feature point from a known relative relationship between the camera 123 and the camera 124 and the internal parameters recorded in the camera parameter initial value 141, and storing three-dimensional coordinates calculated from the distance. The second region observation value 152 is used in the road surface relative posture estimation program 143.

The road surface relative posture 153 is a parameter representing a relative posture between the vehicle 100 and the road surface, and is obtained from the road surface relative posture estimation program 143. The road surface relative posture 153 is used for calculation of the external parameter 154.

The external parameter 154 is a relationship between the positions and the postures of the cameras 121 to 124 and the vehicle 100 including a road surface gradient and a posture variation of the vehicle 100. Based on the external parameter of the camera parameter initial value 141, the external parameters are calculated in the road surface relative posture estimation program 143 and is used in the monocular distance measurement program 145.

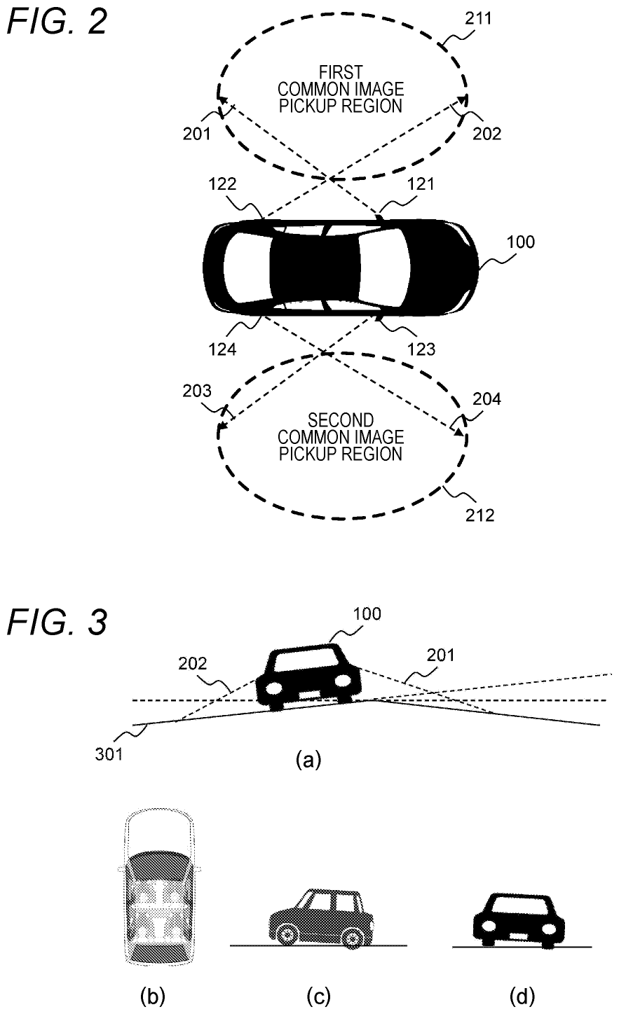

FIG. 2 is a diagram illustrating an example of a relationship among the vehicle 100, the cameras 121 to 124, an optical axis 201 of the camera 121, an optical axis 202 of the camera 122, an optical axis 203 of the camera 123, an optical axis 204 of the camera 124, a first common image pickup region 211, and a second common image pickup region 212.

The camera 121 is attached, for example, under a side mirror on a left side in a traveling direction of the vehicle 100 to capture an oblique rear side of the vehicle 100, that is, a direction of the optical axis 201. Similarly, the camera 123 is attached, for example, under a side mirror on a right side in the traveling direction of the vehicle 100 to capture an oblique rear side of the vehicle 100, that is, a direction of the optical axis 203. The camera 122 is attached, for example, in the vicinity of a C pillar on the left side in the traveling direction of the vehicle 100 to capture an oblique front side of the vehicle 100, that is, a direction of the optical axis 202. Similarly, the camera 124 is attached, for example, in the vicinity of a C pillar on the right side in the traveling direction of the vehicle 100 to capture the oblique front side of the vehicle 100, that is, a direction of the optical axis 204. A region on the left side in the traveling direction of the vehicle 100 imaged by both the camera 121 and the camera 122 is the first common image pickup region 211. In the first common image pickup region 211, the road surface and the three-dimensional object are imaged. The cameras are disposed in this manner, and thus, there are advantages that resolutions of the camera 121 and the camera 122 are high, a common image pickup region can be generated in the vicinity of an optical axis center with less image distortion, and the oblique front side and oblique rear side which are important in sensing of the on-vehicle camera can be imaged. Further, a camera having a matching angle of view, angle, or the like may be selected to function as a peripheral vision camera that displays an overhead view of the periphery of the vehicle 100. Similarly, a region on the left side in the traveling direction of the vehicle 100 captured by both the camera 123 and the camera 124 is the second common image pickup region 212. In the second common image pickup region 212, the road surface and the three-dimensional object are imaged. The imaging results in the first common image pickup region 211 and the second common image pickup region 212 are used for estimating the relative posture between the road surface and vehicle 100.

FIG. 3 (a) is a diagram illustrating an example of a gradient, FIG. 3 (b) is a diagram illustrating an example of a loading situation, and FIGS. 3 (c) and 3 (d) are diagrams illustrating an example of a vehicle posture variation.

A drainage gradient of about 2% in a transverse direction is given to the road with a road center as a vertex such that rainwater does not accumulate on the road. On an expressway where a speed of the vehicle 100 is high, since it is necessary to set a water film of the road surface to be thinner, a drainage gradient of about 2.5% is given. FIG. 3 (a) illustrates an example of the drainage gradient. The vehicle 100 is traveling on a road surface 301, and the drainage gradient is given to the road surface 301 with the road center as the vertex. Since an observation target is placed on the same plane as the vehicle 100 in the direction of the optical axis 202 from the vehicle 100, there is no influence of an error due to the drainage gradient in the distance measurement in the direction of the optical axis 202. On the other hand, since the observation target is not on the same plane as the vehicle 100 in the direction of the optical axis 201 from the vehicle 100, a distance is erroneously calculated under the assumption that the observation target is on the same plane as the vehicle 100. Therefore, it is necessary to estimate a relative relationship between the vehicle 100 and the road surface 301 and correct the estimated distance based on the estimation result.

FIG. 3 (b) is a diagram illustrating an example of the loading situation. The posture of the vehicle 100 with respect to the road surface changes depending on the loading situation of the vehicle 100. For example, in a case where a heavy load is loaded on a rear part of the vehicle 100, a front side of the vehicle 100 is in a floating posture as illustrated in FIG. 3 (c). In a case where only the driver is on the left front seat of the vehicle 100, the left side of the vehicle 100 is in a floating posture as illustrated in FIG. 3 (d). In a case where an occupant is in a driver's seat and a rear seat of the driver's seat of the vehicle 100, the occupant takes a further different posture. In this manner, the posture of the vehicle 100 variously changes depending on the loading situation. When the posture of the vehicle 100 changes in this manner, since the relative posture between the vehicle 100 and the road surface 301 illustrated in FIG. 3 (a) changes, it is necessary to estimate the relative posture relationship between the vehicle 100 and the road surface 301 including the posture change due to the loading situation and correct the estimated distance based on the estimation result.

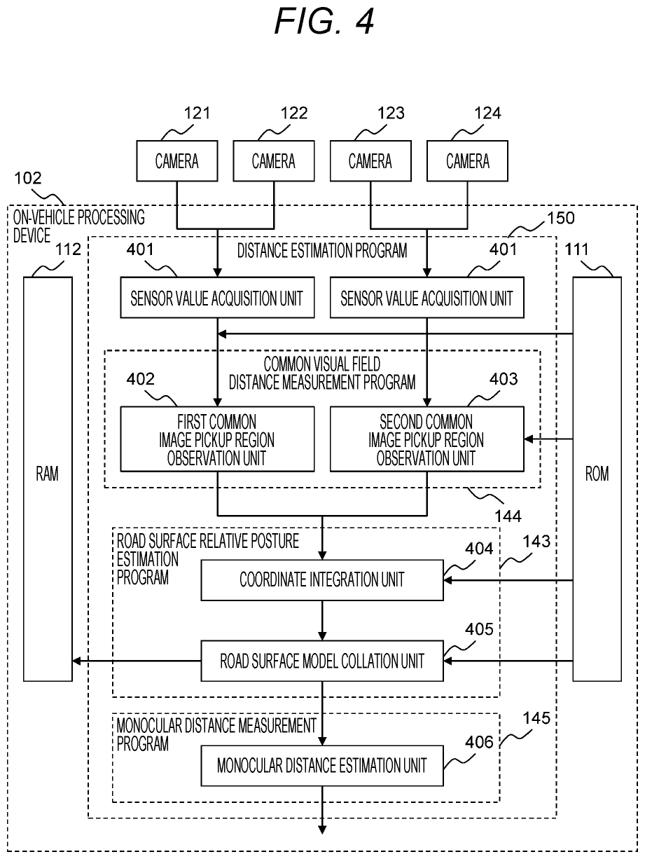

FIG. 4 is a functional block diagram of the distance estimation program 150 executed by the CPU 110. FIG. 4 illustrates a processing order of functional blocks of the distance estimation program 150 and flows of data between the functional blocks and between the functional blocks, the ROM 111, and the RAM 112.

The distance estimation program 150 includes a sensor value acquisition unit 401, a first common image pickup region observation unit 402, a second common image pickup region observation unit 403, a coordinate integration unit 404, a road surface model collation unit 405, and a monocular distance estimation unit 406. The functional blocks corresponding to the common visual field distance measurement program 144 are the first common image pickup region observation unit 402 and the second common image pickup region observation unit 403, the functional blocks corresponding to the road surface relative posture estimation program 143 are the coordinate integration unit 404 and the road surface model collation unit 405, and the functional block corresponding to the monocular distance measurement program 145 is the monocular distance estimation unit 406.

The sensor value acquisition unit 401 acquires images output from the plurality of cameras 121 to 124. The cameras 121 to 124 continuously performs capturing at a predetermined frequency (for example, 30 times per second). The image obtained by the camera is transmitted to the on-vehicle processing device 102 whenever the image is captured. In the case of this example, it is desirable that the cameras 121 and 122, and the camera 123 and the camera 124 are synchronized in some methods and perform capturing in synchronization. The sensor value acquisition unit 401 outputs the images captured by the cameras 121 to 124 to the first common image pickup region observation unit 402 and the second common image pickup region observation unit 403. Thereafter, kinds of processing of the first common image pickup region observation unit 402 to the monocular distance estimation unit 406 are executed whenever the image is received.

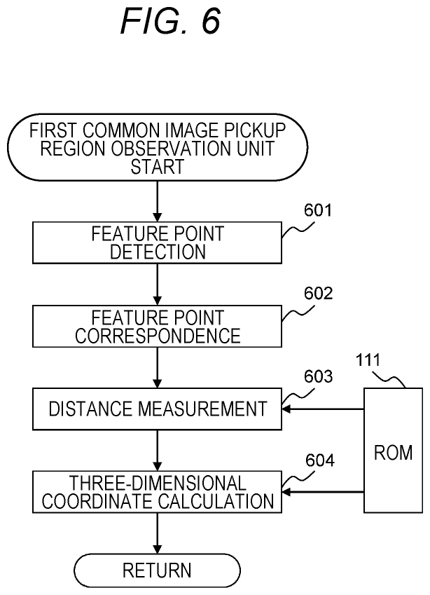

The first common image pickup region observation unit 402 measures three-dimensional coordinate values of the road surface 301 captured in the first common image pickup region 211 by using the images captured by the plurality of cameras 121 122 output and from the sensor value acquisition unit 401. For example, a common object (for example, a portion that can be easily found as a feature point such as a corner portion of road surface paint) captured by the image of the camera 121 and pixels corresponding to the road surface 301 of the camera 122 is extracted by image recognition, and the three-dimensional coordinate values of the road surface 301 can be measured by triangulation using a known geometric relationship (for example, the calibrated camera parameter initial value 141 stored in the ROM 111) between the camera 121 and the camera 122. The calculation is performed by a plurality of feature points on the road surface that can be associated in the camera 121 and the camera 122. Whether or not a certain pixel is on the road surface may be determined in a range calculated by giving a certain error range to the known relationship between the posture angle of the camera parameter initial value 141 and the road surface gradient, or the road surface may be determined by distinguishing the three-dimensional object on the captured image. The three-dimensional coordinate values may be measured by other known methods. The calculated distance is calculated, for example, in a camera coordinate system having the optical axis 201 of the camera 121 as one axis. The first common image pickup region observation unit 402 outputs all the calculated three-dimensional coordinate values of the road surface 301 to the coordinate integration unit 404. A processing flow of the first common image pickup region observation unit 402 will be described with reference to FIG. 6.

The second common image pickup region observation unit 403 measures the three-dimensional coordinate values of the road surface 301 captured in the second common image pickup region 212 by using the images captured by the plurality of cameras 123 and 124 output from the sensor value acquisition unit 401. The processing of the second common image pickup region observation unit 403 is the same as the processing of the first common image pickup region observation unit 402 except that the camera that captures the image is different and that the second common image pickup region 212 is captured, and thus, the detailed description will be omitted.

The coordinate integration unit 404 is a functional block that integrates three-dimensional coordinates of the road surface 301 output from the first common image pickup region observation unit 402 and three-dimensional coordinates of the road surface 301 output from the second common image pickup region observation unit 403 into the same coordinate system.

The first common image pickup region observation unit 402 calculates three-dimensional coordinate values in the camera coordinate system of the camera 121, for example. On the other hand, the second common image pickup region observation unit 403 calculates three-dimensional coordinate values in the camera coordinate system of the camera 123, for example. The coordinate integration unit 404 converts the coordinate values in these different coordinate systems into, for example, a vehicle coordinate system by using the calibrated camera parameter initial value 141 stored in the ROM 111, and integrates the coordinate values. The conversion and integration into the vehicle coordinate system can be performed by known coordinate conversion calculation by using an external parameter representing a positional and postural relationship in the camera parameter initial value 141.

The coordinate system in which the coordinates are integrated may be another coordinate system. The three-dimensional coordinate values obtained by integrating the first common image pickup region 211 and the second common image pickup region 212 output from the first common image pickup region observation unit 402 and the second common image pickup region observation unit 403 are output to the road surface model collation unit 405.

The road surface model collation unit 405 calculates the relative posture relationship between the vehicle 100 and the road surface 301 by fitting the road surface model 142 by using the three-dimensional coordinate values obtained by integrating the first common image pickup region 211 and the second common image pickup region 212 output from the coordinate integration unit 404. The relative posture relationship is calculated including the vehicle posture variation illustrated in FIGS. 3 (c) and 3 (d).

The road surface model 142 includes, for example, two planes having a drainage gradient of about 2% in consideration of a road structure to which a gradient of about 2% to 2.5% is given in the transverse direction with the road center as the vertex. Other road surface models will be described later.

The road surface model collation unit 405 obtains the relative posture of the road surface model 142 with respect to the vehicle 100 such that the road surface model 142 and the three-dimensional coordinate values obtained by integrating the first common image pickup region 211 and the second common image pickup region 212 output from the coordinate integration unit 404 most coincide with each other. For example, the sum of distances between the three-dimensional coordinate values obtained by integrating the first common image pickup region 211 and the second common image pickup region 212 output from the coordinate integration unit 404 and the road surface plane of the road surface model 142 is set as an objective function, and relative position and posture parameters of the road surface model 142 with respect to the vehicle 100 is calculated to minimize the objective function. The relative position and posture parameters of the vehicle 100 and the road surface model 142 are one or more of three posture angles of a roll angle, a pitch angle, and a yaw angle, and position parameters of length, width, and height. For stabilization of the estimation, one or more parameters may be known, and other parameters may be estimated. For the minimization of the objective function, a known objective function minimization method such as a steepest descent method or a Levenberg-Marquardt method can be used. The relative position and posture parameters of the vehicle 100 and the road surface 301 obtained by the road surface model collation unit 405 are output as the road surface relative posture 153 to the monocular distance estimation unit 406. In addition, the relative position and posture parameters are stored as the road surface relative posture 153 in the RAM 112 to be utilized as an initial value of optimization at a next time. At the next time, the road surface relative posture 153 is read from the RAM 112, and the objective function is minimized as an initial value. Then, a new road surface relative posture obtained from new three-dimensional coordinate values is stored as the road surface relative posture 153 in the RAM 112. Note that, the road surface model collation unit 405 may obtain the relative position and posture of the vehicle 100 by another method without using the road surface model.

The monocular distance estimation unit 406 calculates an accurate distance to the object by using the road surface relative posture 153 and the road surface model 142 output from the road surface model collation unit 405. From the road surface model 142, the road surface relative posture 153, and the camera parameter initial value 141, the relative relationship between the cameras 121 to 124 and the road surface 301 can be calculated by a known geometric solution. The distance to the object is calculated based on a pixel corresponding to a road surface installation point of the object by using the calculated relative relationship, and is output as the estimated distance. This object may be detected by, for example, an image recognition function using AI or the like provided in the cameras 121 to 124. The distance to the object can also be calculated in a portion other than the common image pickup regions 211 and 212 of the cameras 121 to 124, and can be correctly calculated even in a case where the road surface is not flat over a wide range by a plurality of cameras.

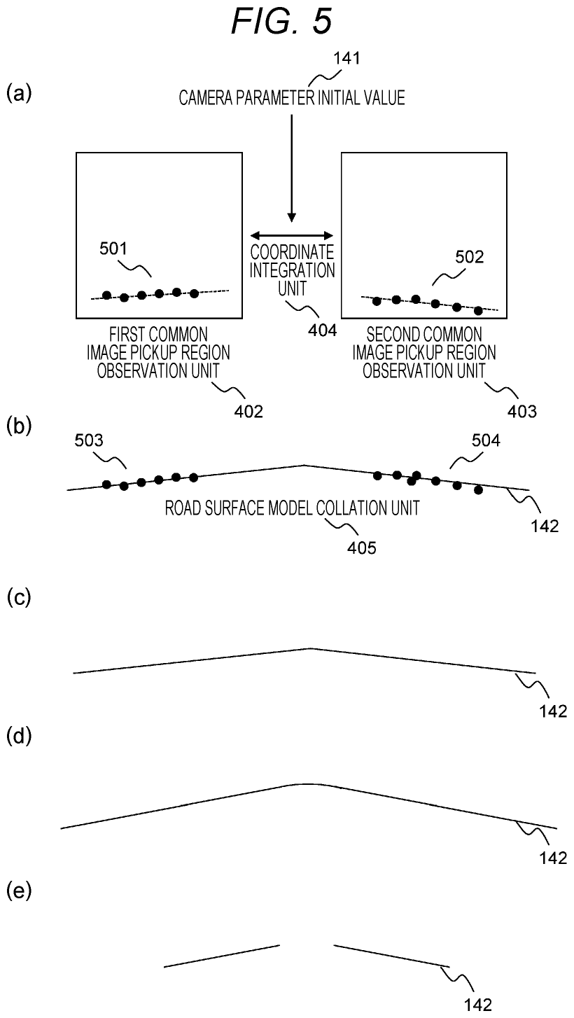

FIGS. 5 (a) and 5 (b) are schematic diagrams illustrating kinds of processing of coordinate integration and road surface model collation. FIGS. 5 (a) and 5 (b) illustrate a relationship among the first common image pickup region observation unit 402, the second common image pickup region observation unit 403, the coordinate integration unit 404, and the road surface model collation unit 405, an outline of processing thereof, and advantages thereof.

Three-dimensional coordinate values 501 of the road surface 301 in the first common image pickup region 211 observed by the first common region image pickup observation unit 402 are represented by the camera coordinate system of the camera 121, and three-dimensional coordinate values 502 of the road surface 301 in the second common image pickup region 212 observed by the second common image pickup region observation unit 403 are represented by the camera coordinate system of the camera 123. A relative relationship between the three-dimensional coordinate value 501 and the three-dimensional coordinate value 502 is unknown. Here, the coordinate integration unit 404 converts the three-dimensional coordinate values 501 of the camera coordinate system into three-dimensional coordinate values 503 of the coordinate system of the vehicle 100 and converts the three-dimensional coordinate values 502 of the camera coordinate system into three-dimensional coordinate values 504 of the coordinate system of the vehicle 100 by using the external parameters of the camera parameter initial value 141. The three-dimensional coordinate values 503 and the three-dimensional coordinate values 504 are represented by the same coordinate system, and the relative relationship is clear. The road surface model collation unit 405 can obtain the relative relationship between the vehicle 100 and the road surface 301 by collating the three-dimensional coordinate values 503 and the three-dimensional coordinate values 504 with the road surface model 142. The road surface can be stably estimated by observation values in a wide range and constraints by a model compared to be individually estimated in each common image pickup region by utilizing not only one side of the vehicle 100 but also regions on both sides of the vehicle 100 and further fitting these regions to the road surface model 142, and the relative relationship between the vehicle 100 and the road surface can be obtained with high accuracy. As a result, even in a case where the road is not flat, distance measurement accuracy using the images captured by the plurality of cameras can be improved.

FIGS. 5 (c), 5 (d), and 5 (e) are diagrams illustrating an example of the road surface model 142. FIG. 5 (c) is a model in which two planes having a gradient of 2% are connected. FIG. 5 (d) illustrates a model in which apexes of two planes having a gradient of 2% are curved surfaces. FIG. 5 (e) is a model in which a road surface top and a width of the road surface are excluded in order to correspond to various shapes of the road surface top and the width of the road surface plane. A corresponding point close to the excluded portion can be flexibly collated by not including the corresponding point in the error sum of the objective function at the time of collating the road surface with the three-dimensional coordinate values. In addition, on an expressway having three lanes on each side and having a median strip, there is a case where a plane is formed over the entire width of three lanes on each side. The road surface model 142 of FIGS. 5 (c) to 5 (e) can correspond to a case where the entire width is one plane. That is, when the road surface model 142 is greatly slid to the left or right, the entire observation range becomes a flat road surface. In the example illustrated here, an example of a model in which two planes are connected in accordance with a shape of a road cross gradient is illustrated, but a model in which two or more planes are connected may be used.

FIG. 6 is a flowchart of kinds of processing executed by the first common image pickup region observation unit 402. In the first common image pickup region observation unit 402, whenever the image is received from the sensor value acquisition unit 401, the CPU 110 executes kinds of processing of the following steps.

In feature point detection step 601, a feature point (for example, a corner point of the road surface paint), which is a characteristic point in the image, is detected from each of two images obtained from the sensor value acquisition unit 401. A detection range is a road surface in the e common image pickup region of the two images.

Whether or not a certain pixel is on the road surface in the common image pickup region may be determined by a portion calculated by giving a certain error range to the known relationship between the posture angle of the camera parameter initial value 141 and the road surface gradient, or may be determined by discriminating the three-dimensional object and the road surface on the captured image. The feature point is detected by using a known feature point extraction technique such as Harris operator. In addition, information expressing the feature point may be attached by a known technique such as ORB and may be used in a next feature point correspondence step. Subsequently, the processing proceeds to step 602.

In feature point correspondence step 602, points representing the same target are associated from the feature points of the two images obtained in feature point detection step 601. For example, the feature points are associated by using the feature point information obtained for each feature point in step 601. Specifically, a feature point having a closest feature point information to the feature point of one image is selected from the other image, and two feature points are associated with each other. In order to improve the feature point coordinates and the association accuracy of the feature points, any known technique may be used. Subsequently, the processing proceeds to step 603.

In distance measurement step 603, a three-dimensional distance of each point is calculated by using a correspondence between the two images obtained in step 602. The three-dimensional distance can be calculated by applying the principle of triangulation to two corresponding coordinate points by using the geometric relationship between two cameras 121 and 122 obtained from the camera parameter initial value 141 stored in the ROM 111. Here, for the sake of description, the calculation is performed as a distance viewed from the camera 121 with the camera 121 as a reference, but the calculation may be performed with the camera 122 as a reference. In this case, there is no problem when the geometric calculation is performed in accordance with the reference camera in a subsequent stage. In order to ensure accuracy, the calculation may be performed by using any known technique. Subsequently, the processing proceeds to step 604.

In three-dimensional coordinate calculation step 604, three-dimensional coordinate values are calculated from the coordinates and the distance on the image of the camera 121 obtained in step 603. The three-dimensional coordinates can be calculated from the coordinates and the distance on the image by the known geometric calculation by using the camera parameter initial value 141. The three-dimensional coordinates calculated here are the camera coordinates of the camera 121. The three-dimensional coordinates of each point are output, and the flowchart is ended.

Although the kinds of processing executed by the first common image pickup region observation unit 402 have been described above with reference to FIG. 6, kinds of processing executed by the second common image pickup region observation unit 403 are the same as the kinds of processing executed by the first common image pickup region observation unit only because the camera image and the camera parameters and the like associated therewith are different.

### Modification Example 1

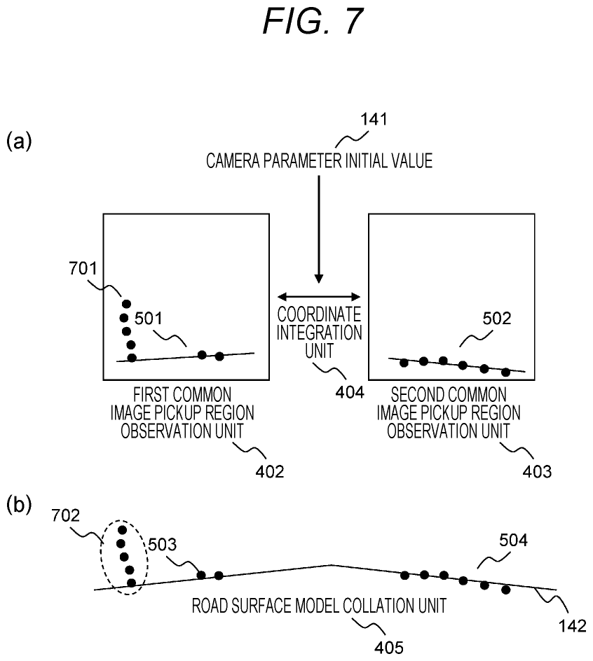

FIGS. 7 (a) and 7(b) are schematic diagrams illustrating a modification example of kinds of processing of coordinate integration and road surface model collation. FIGS. 7 (a) and 7 (b) illustrate a relationship among the first common image pickup region observation unit 402, the second common image pickup region observation unit 403, the coordinate integration unit 404, and the road surface model collation unit 405, an outline of processing thereof, and advantages thereof. FIGS. 7 (a) and 7 (b) are a modification example of FIGS. 5 (a) and 5 (b), the description of the common portions will be omitted, and differences will be described.

Three-dimensional coordinate values 701 are three-dimensional coordinate values of the three-dimensional object observed in the first common image pickup region 211 and represented by the camera coordinate system of the camera 121. The coordinate integration unit 404 converts the three-dimensional coordinate values 701 of the three-dimensional object into three-dimensional coordinate values 702 of the coordinate system of the vehicle 100 by using the external parameters of the camera parameter initial value 141. The road surface model 142 may be collated by using not only the three-dimensional coordinate values 503 and 504 but also the three-dimensional coordinate values 702. In this case, it is considered that the three-dimensional coordinate values 702 are vertically arranged, and the objective function of the road surface model 142 is designed such that an evaluation value becomes large in a case where the three-dimensional coordinate values are vertical.

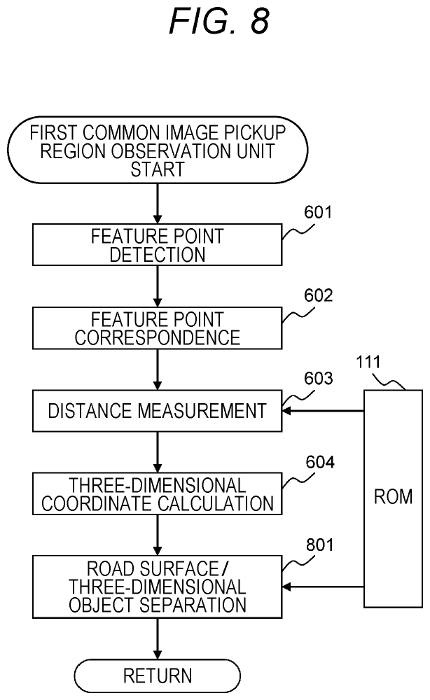

FIG. 8 is a flowchart of kinds of processing executed by the first common image pickup region observation unit 402, and to corresponds the modification example illustrated in FIG. 7. Since the flowchart of FIG. 8 is substantially the same as the flowchart of FIG. 6, the description of the common portions will be omitted, and differences will be described.

In road surface/three-dimensional object separation step 801, an observation point on the road surface and an observation point of the three-dimensional object are separated 1 from observation points of the common image pickup regions. For example, due to the use of image recognition by AI or the like, observation points may be separated by leveling a point recognized as a guardrail, a utility pole, a pole, or the like to the three-dimensional object, leveling a point recognized by road surface paint as a point on the road surface. Similarly, the three-dimensional object is grouped by attaching another label to each three-dimensional object. Rectangles are fitted to the grouped point to give rectangle information. Regarding the given rectangle information, the road surface model collation unit 405 in the subsequent stage designs and uses an objective function that is minimized in a case where the rectangle and the road surface model 142 are orthogonal to each other. Here, the labeled three-dimensional coordinate point is output, and the flowchart is ended.

Although the kinds of processing executed by the first common image pickup region observation unit 402 have been described above with reference to FIG. 8, the kinds of processing executed by the second common image pickup region observation unit 403 are the same as the kinds of processing executed by the first common image pickup region observation unit only because the camera image and the camera parameters and the like associated therewith are different.

### Modification Example 2

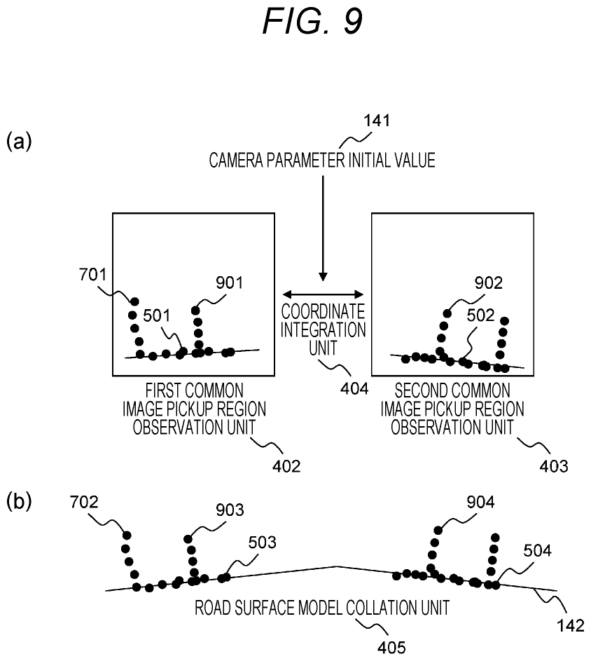

FIGS. 9 (a) and 9 (b) are schematic diagrams illustrating a further modification example of the processing of coordinate integration and road surface model collation. FIGS. 9 (a) and 9 (b) illustrate a relationship among the first common image pickup region observation unit 402, the second common image pickup region observation unit 403, the coordinate integration unit 404, and the road surface model collation unit 405, an outline of processing thereof, and advantages thereof. FIGS. 9 (a) and 9 (b) are a modification example of FIGS. 7 (a) and 7(b), the description of the common portions will be omitted, and differences will be described.

Three-dimensional coordinate values 901 are three-dimensional coordinate values of the three-dimensional object observed at a next time of the three-dimensional coordinate values 501 and 701 in the first common image pickup region 211. That is, the observation points in the first common image pickup region 211 are integrated in time series on the premise that the posture of the vehicle 100 does not change greatly in a short time. Similarly, three-dimensional coordinate values 902 are three-dimensional coordinate values of the three-dimensional object observed at a next time of the three-dimensional coordinate values 502 in the second common image pickup region 212, and are obtained by integrating coordinate points of the second common image pickup region 212 in time series. Here, the coordinate integration unit 404 converts the three-dimensional coordinate values 901 and 902 into the coordinate system of the vehicle 100 by using the external parameters of the camera parameter initial value 141. The road surface model 142 is collated by using not only the three-dimensional coordinate values 503 and 504 but also the three-dimensional coordinate values 702, 901, and 902. In this case, it is considered that the three-dimensional coordinate values 901 and 902 are also vertically arranged, and the objective function of the road surface model 142 is designed such that the evaluation value becomes large in a case where the three-dimensional coordinate values are vertical.

According to this modification example, the road surface can be stably estimated by observation values in a wide range and constraints by a model compared to be individually estimated with an observation value at a point in time which is each common image pickup region by utilizing not only road surface points and three-dimensional object points observed at a certain point in time on both sides of the vehicle 100 but also road surface points and three-dimensional object points in time-series and further fitting these points to the road surface model 142, and the relative relationship between the vehicle 100 and the road surface can be obtained with high accuracy. As a result, even in a case where the road is not flat, the distance measurement accuracy using the images captured by the plurality of cameras can be further improved.

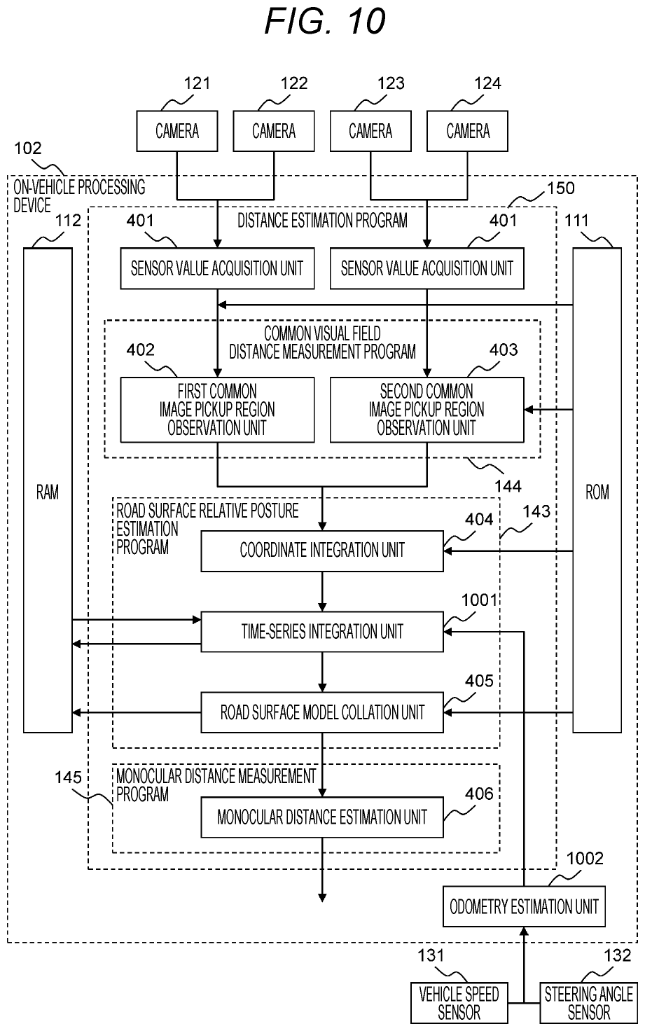

FIG. 10 is a functional block diagram of the distance estimation program 150 executed by the CPU 110, and corresponds to a modification example illustrated in FIG. 9. FIG. 10 illustrates a processing order of functional blocks of the distance estimation program 150, and flows of data between the functional blocks and between the functional blocks, the ROM 111, and the RAM 112. Since the functional block diagram of FIG. 10 is substantially the same as the functional block diagram of FIG. 4, the description of the common portions will be omitted, and differences will be described.

The distance estimation program 150 includes a sensor value acquisition unit 401, a first common image pickup region observation unit 402, a second common image pickup region observation unit 403, a coordinate integration unit 404, a time-series integration unit 1001, a road surface model collation unit 405, a monocular distance estimation unit 406, and an odometry estimation unit 1002. The time-series integration unit 1001 is one of the functional blocks corresponding to the road surface relative posture estimation program 143, and integrates, in time series, the three-dimensional coordinate values obtained by integrating the first common image pickup region 211 and the second common image pickup region 212 output from the coordinate integration unit 404. The three-dimensional coordinate values are integrated on the premise that the posture of the vehicle 100 does not change significantly in a short time. At the time of integration, the three-dimensional coordinate values can be integrated by acquiring a movement amount of the vehicle 100 from a previous time to a current time and calculating a movement amount of the camera from the movement amount of the vehicle by known geometric calculation. The vehicle movement amount is acquired from the odometry estimation unit 1002 to be described later. At the first time, the output of the coordinate integration unit 404 is written and recorded in the RAM 112, and from the next time on, a point group recorded at the previous time is read from the RAM 112 and is retained in addition to a point group in the coordinate system of the vehicle 100 newly obtained from the coordinate integration unit 404. A time range to be integrated may be adjusted as a parameter. The integrated three-dimensional coordinate values are output to the road surface model collation unit 405 and the RAM 112.

The odometry estimation unit 1002 estimates the motion of the vehicle 100 by using the speed and the steering angle of the vehicle 100 transmitted from the vehicle speed sensor 131 and the steering angle sensor 132. For example, known dead reckoning may be used, estimation may be performed by using a known visual odometry technique using a camera, or a known Kalman filter or the like may be used in combination. The vehicle motion estimation result is output to the time-series integration unit 1001.

### Modification Example 3

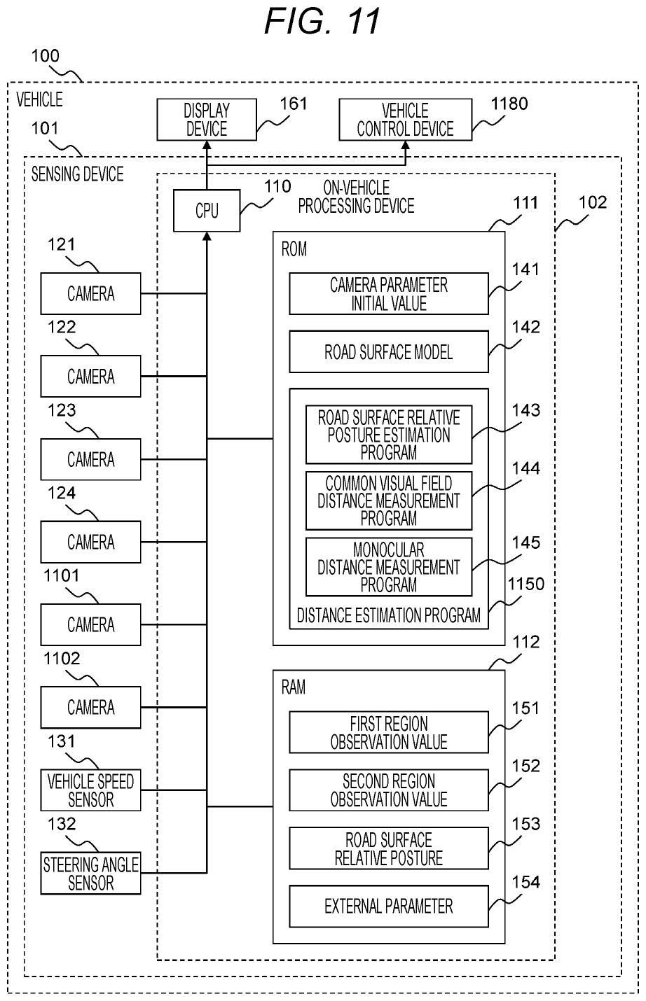

FIG. 11 is a block diagram illustrating a configuration of a vehicle 100 on which a sensing device 101 according to a modification example of the present invention is mounted. Since the sensing device 101 illustrated in FIG. 11 is substantially the same as the sensing device 101 illustrated in FIG. 1, the description of the common portions will be omitted, and differences will be described.

In the sensing device 101 illustrated in FIG. 11, a camera 1101, a camera 1102, and a vehicle control device 1180 are additionally mounted on the sensing device 101 illustrated in FIG. 1. The camera 1101 and the camera 1102 are attached to the periphery of the vehicle 100 similarly to the cameras 121 to 124, and capture the periphery of the vehicle 100. A method for attaching the cameras 1101 and 1102 will be described later. A capturing range of the cameras 1101 and 1102 includes a road surface on which the vehicle 100 travels. A relationship between the positions and postures of the cameras 1101 and 1102 and the vehicle 100 is stored as a camera parameter initial value 141 in the ROM 111. Each of the cameras 1101 and 1102 includes a lens and an image pickup element. Characteristics of the cameras 1101 and 1102, for example, a lens distortion coefficient indicating distortion of a lens, an optical axis center, a focal length, the number of pixels of the image pickup element, dimensions, and the like are also stored as the camera parameter initial value 141 in the ROM 111.

The vehicle control device 1180 controls a steering device, a driving device, a braking device, an active suspension, and the like by using the information output from the CPU 110, for example, a road surface relative posture 153 output from the distance estimation program 1150. The steering device operates the steering of the vehicle 100. The driving device applies a driving force to the vehicle 100. The driving device increases the driving force of the vehicle 100, for example, by increasing a target rotation speed of an engine of the vehicle 100. The braking device applies a braking force to the vehicle 100. The active suspension can change operations of various devices during traveling, such as expansion and contraction of an actuator operated by hydraulic pressure, air pressure, or the like, or adjustment of intensity of a damping force of a spring.

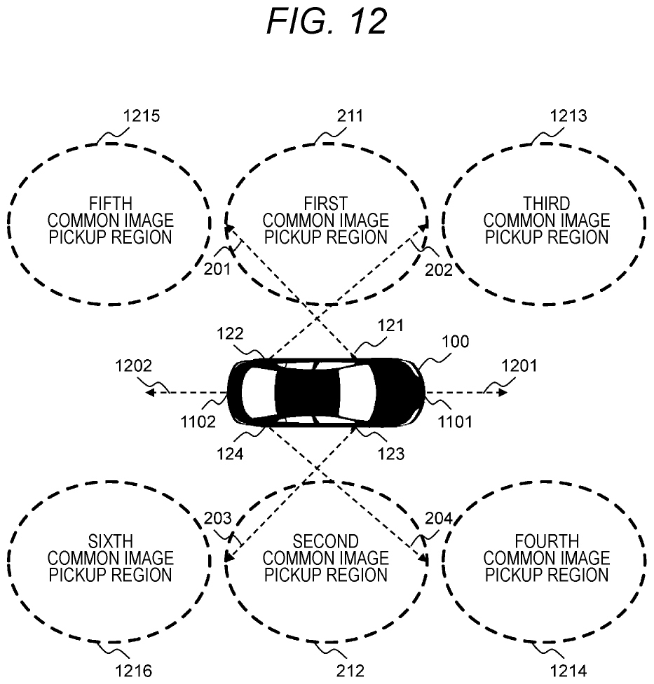

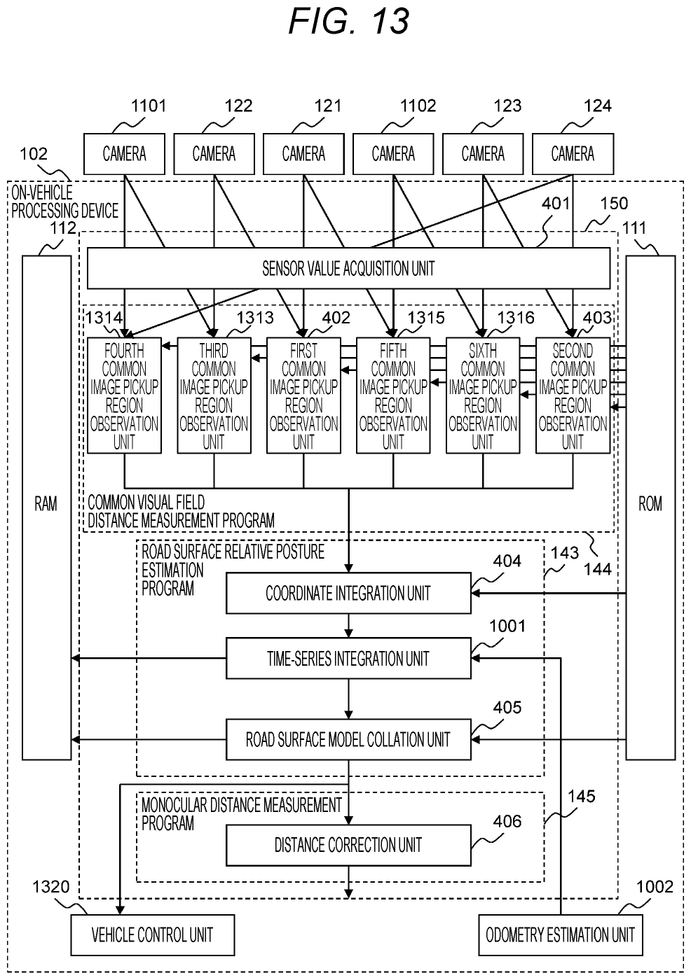

FIG. 12 is a diagram illustrating an example of a relationship among the vehicle 100, the cameras 121 to 124, 1101, and 1102, an optical axis 201 of the camera 121, an optical axis 202 of the camera 122, an optical axis 203 of the camera 123, an optical axis 204 of the camera 124, an optical axis 1201 of the camera 1101, an optical axis 1202 of the camera 1102, a first common image pickup region 211, a second common image pickup region 212, a third common image pickup region 1213, a fourth common image pickup region 1214, a fifth common image pickup region 1215, and a sixth common image pickup region 1216 in the sensing device 101 of the modification example illustrated in FIG. 11.

The camera 1101 is attached by selecting an angle of view and the like of the camera in front of the vehicle 100 to capture a direction of the optical axis 1201 and to have a common image pickup region with the cameras 122 and 124. The common image pickup region of the camera 1101 and the camera 122 is the third common image pickup region 1213, and the common image pickup region of the camera 1101 and the camera 124 is the fourth common image pickup region 1214. The camera 1102 is attached by selecting an angle of view of the camera in rear of the vehicle 100 to capture a direction of the optical axis 1202 and to have a common image pickup region with the cameras 121 and 123. The common image pickup region of the camera 1102 and the camera 121 is the fifth common image pickup region 1215, and the common image pickup region of the camera 1102 and the camera 123 is the sixth common image pickup region 1216. In each common image pickup region, the road surface and the three-dimensional object are captured. Further, a camera having a matching angle of view, angle, or the like may be selected to function as a peripheral vision camera that displays an overhead view of the periphery of the vehicle 100. The imaging results in the common image pickup regions 211, 212, and 1213 to 1216 are used for estimating the relative posture between the road surface and the vehicle 100. In the modification example illustrated in FIG. 12, the relative relationship between the vehicle 100 and the road surface can be stably estimated by the observation value in a wider range, and can be obtained with high accuracy. As a result, even in a case where the road is not flat, distance measurement accuracy using the images captured by the plurality of cameras can be improved.

FIG. 13 is a functional block diagram of the distance estimation program 150 executed by the CPU 110, and corresponds to the modification example illustrated in FIG. 11. FIG. 13 illustrates a processing order of functional blocks of the distance estimation program 150, and flow of data between the functional blocks and between the functional blocks, the ROM 111, and the RAM 112. Since the functional block diagram of FIG. 13 is substantially the same as the functional block diagram of FIG. 10, the description of the common portions will be omitted, and differences will be described.

A common visual field distance measurement program 144 illustrated in FIG. 13 includes a first common image pickup region observation unit 402, a second common image pickup region observation unit 403, a third common image pickup region observation unit 1313, a fourth common image pickup region observation unit 1314, a fifth common image pickup region observation unit 1315, and a sixth common image pickup region observation unit 1316. In addition, images are input from the cameras 121 to 124 and the cameras 1101 and 1102 to the common visual field distance measurement program 144.

The third common image pickup region observation unit 1313 measures the three-dimensional coordinate values of the road surface 301 captured in the third common image pickup region 1213 by using the images captured by the plurality of cameras 122 and 1101 output from the sensor value acquisition unit 401. The fourth common image pickup region observation unit 1314 measures the three-dimensional coordinate values of the road surface 301 captured in the fourth common image pickup region 1214 by using the images captured by the plurality of cameras 124 and 1101 output from the sensor value acquisition unit 401. The fifth common image pickup region observation unit 1315 measures the three-dimensional coordinate values of the road surface 301 captured in the fifth common image pickup region 1215 by using the images captured by the plurality of cameras 121 and 1102 output from the sensor value acquisition unit 401. The sixth common image pickup region observation unit 1316 measures the three-dimensional coordinate values of the road surface 301 captured in the sixth common image pickup region 1216 by using the images captured by the plurality of cameras 123 and 1102 output from the sensor value acquisition unit 401. The three-dimensional coordinate values output from the common image pickup region observation units are represented in the camera coordinate system of each camera, and the three-dimensional coordinate values of the camera coordinate system are converted into the three-dimensional coordinate values of the coordinate system of the vehicle 100 by using the external parameters of the camera parameter initial value 141.

A vehicle control unit 1320 receives a road surface relative posture 153 which is an output of a road surface model collation unit 405, and controls the vehicle 100. As an example of the vehicle control, an active suspension is controlled to reduce the influence of a roll angle and a pitch angle of the vehicle 100 obtained from the road surface relative posture 153, and the ride comfort is improved. The vehicle 100 may be controlled by other posture angles of the vehicle 100.

As described above, the sensing device 101 of the embodiment of the present invention includes a first common image pickup region observation unit 402 that observes a first common image pickup region 211 in a periphery of a host vehicle from information of a common image pickup region acquired by at least a first sensor (camera 121) and a second sensor (cameral 122) having the common image pickup region, a second common image pickup region observation unit 403 that observes a second common image pickup region 212 different from the first common image pickup region 211 from information of a common image pickup region acquired by at least a third sensor (camera 123) and a fourth sensor (camera 124) having the common image pickup region, a coordinate integration unit 404 that integrates a geometric relationship between the sensors with coordinates of pieces of information observed in the first common image pickup region 211 and the second common image pickup region 212, and a road surface estimation unit (road surface model collation unit 405) that estimates a relative posture between each sensor and a road surface including a pitch angle and a roll angle of the host vehicle based on point group information calculated from the integrated coordinates. Thus, it is possible to reduce the influence of the road gradient and the vehicle posture and to improve the distance measurement accuracy. In addition, the accuracy at the time of binocular distance measurement by the plurality of cameras can be improved.

In addition, since the common image pickup region is disposed at a position where the optical axes of the sensors intersect with each other, it is possible to accurately correct the influence of the road gradient and the vehicle posture by using an image with less distortion in the vicinity of the optical axes.

In addition, the road surface estimation unit (road surface model collation unit 405) includes the road surface model collation unit 405 that collates the point group information of the road surface with the road surface model, and the road surface model collation unit 405 fits the point group information of the road surface to the road surface model 142 such that the error between the point group information of the road surface and the road surface model 142 decreases. Thus, it is possible to accurately correct the influence of the road gradient and the vehicle posture.

In addition, the first common image pickup region observation unit 402 and the second common image pickup region observation unit 403 separate road surface point group information and object point group information representing an object present on the road surface (801), and the road surface estimation unit (road surface model collation unit 405) performs collation with a road surface model such that an error between the road surface point group information and the road surface decreases and the object point group information is vertically arranged. Thus, it is possible to accurately correct the influence of the road gradient and the vehicle posture without causing a large error.

In addition, the road surface estimation unit (road surface model collation unit 405) includes a time-series integration unit 1001 that integrates, in time series, outputs of the first common image pickup region observation unit, and integrates, in time series, outputs of the second common image pickup region observation unit. Thus, it is possible to accurately correct the influence of the road gradient and the vehicle posture, and robustness of the road surface estimation is improved.

In addition, pieces of information acquired by six sensors are received, and the road surface estimation unit (road surface model collation unit 405) estimates the relative posture between each sensor and the road surface including the pitch angle of the host vehicle and the roll angle of the vehicle based on point group information calculated by integrating coordinates of information observed in a common image pickup region of a combination of two sensors of the six sensors. Thus, information in a wide region can be used by using many sensors, and it is possible to accurately correct the influence of the road gradient and the vehicle posture. In addition, the accuracy at the time of binocular distance measurement by the plurality of cameras can be improved, and robustness of the road surface estimation is improved.

Note that, the present invention is not limited to the aforementioned embodiments, and includes various modification examples and equivalent configurations within the gist of the appended claims. For example, the aforementioned embodiments are described in detail in order to facilitate easy understanding of the present invention, and the present invention is not limited to necessarily including all the described components. In addition, a part of the configuration of one embodiment may be replaced with the configuration of another embodiment. In addition, the configuration of another embodiment may be added to the configuration of one embodiment. In addition, another configuration may be added, removed, and substituted to, from, and for some of the configurations of the aforementioned embodiments.

In addition, the sensing device 101 may include an input and output interface (not illustrated), and a program may be read from another device via a medium in which the input and output interface and the sensing device 101 can be used as necessary. Here, the medium refers to, for example, a storage medium attachable and detachable from the input and output interface, or a communication medium, that is, a wired, wireless, or optical network, or a carrier wave or a digital signal propagating through the network.

In addition, a part or all of the aforementioned configurations, functions, processing units, and processing means may be realized by hardware by being designed with, for example, an integrated circuit. Alternatively, the processor interprets and executes a program for realizing the functions, and thus, a part or all of the aforementioned configurations, functions, processing units, and processing means may be realized by software. In addition, some or all of the functions implemented by the program may be implemented by a hardware circuit or an FPGA.

Information of programs, tables, and files for realizing the functions can be stored in a storage device such as a memory, a hard disk, or a solid state drive (SSD), or a recording medium such as an IC card, an SD card, or a DVD.

In addition, control lines and information lines illustrate lines which are considered to be necessary for the description, and not all the control lines and information lines necessary in the implementation are necessarily illustrated. Almost all the configurations may be considered to be actually connected to each other.

1. A sensing device, comprising:
a first common image pickup region observation unit that observes a first region in a periphery of a host vehicle from information of a common image pickup region acquired by at least a first sensor and a second sensor having the common image pickup region;
a second common image pickup region observation unit that observes a second region different from the first region from information of a common image pickup region acquired by at least a third sensor and a fourth sensor having the common image pickup region;
a coordinate integration unit that integrates a geometric relationship between the sensors with coordinates of pieces of information observed in the first region and the second region; and
a road surface estimation unit that estimates a relative posture between each sensor and a road surface including a pitch angle and a roll angle of the host vehicle based on point group information calculated from the integrated coordinates.

2. The sensing device according to claim 1, wherein the common image pickup region is disposed at a position where optical axes of the sensors intersect with each other.

3. The sensing device according to claim 1, wherein the road surface estimation unit collates the point group information of the road surface with a road surface model.

4. The sensing device according to claim 3, wherein the road surface estimation unit fits the point group information of the road surface to a road surface model such that an error between the point group information of the road surface and a road surface model decreases.

5. The sensing device according to claim 1, further comprising a distance measurement unit that measures a distance while referring to a corrected value calculated from the estimated relative posture.

6. The sensing device according to claim 1, wherein the first common image pickup region observation unit and the second common image pickup region observation unit separate road surface point group information and object point group information representing an object present on a road surface.

7. The sensing device according to claim 6, wherein the road surface estimation unit performs collation with a road surface model such that an error between the road surface point group information and a road surface decreases, and the object point group information is vertically arranged.

8. The sensing device according to claim 1, further comprising a time-series integration unit that integrates, in time series, outputs of the first common image pickup region observation unit, and integrates, in time series, outputs of the second common image pickup region observation unit.

9. The sensing device according to claim 1, wherein
the first common image pickup region observation unit acquires information on a left side in a traveling direction of the host vehicle, and
the second common image pickup region observation unit acquires information on a right side in the traveling direction of the host vehicle.

10. The sensing device according to claim 1, wherein
pieces of information acquired by six sensors are received, and
the road surface estimation unit estimates a relative posture between each sensor and a road surface including a pitch angle of a host vehicle and a roll angle of a vehicle based on point group information calculated by integrating coordinates of information observed in a common image pickup region of a combination of two sensors of the six sensors.

11. A vehicle control device, comprising:
a first common image pickup region observation unit that observes a first region in a periphery of a host vehicle from information of a common image pickup region acquired by at least a first sensor and a second sensor having the common image pickup region;
a second common image pickup region observation unit that observes a second region different from the first region from information of a common image pickup region acquired by at least a third sensor and a fourth sensor having the common image pickup region;
a coordinate integration unit that integrates a geometric relationship between the sensors with coordinates of pieces of information observed in the first region and the second region; and
a road surface estimation unit that t estimates a relative posture between each sensor and a road surface including a pitch angle and a roll angle of the host vehicle based on point group information calculated from the integrated coordinates,
wherein a vehicle is controlled by using the estimated relative posture.
